(19) United States
(12) Patent Application Publication
(10) Pub. No.: US 2015/0313327 A1
(43) Pub. Date: Nov. 5, 2015

(54) RING AND PROCESS FOR PRODUCING THE SAME

(71) Applicant: FURRER-JACOT AG, Schaffhausen (CH)

(72) Inventor: Lucas RUPPLI, Schaffhausen (CH)

(73) Assignee: Furrer-Jacot AG, Schaffhausen (CH)

(21) Appl. No.: 14/650,497

(22) PCT Filed: Dec. 2, 2013
(86) PCT No.: PCT/CH2013/000206

§ 371 Date: Jun. 8, 2015

(30) Foreign Application Priority Data
Dec. 20, 2012 (CH) 02908/12
May 14, 2013 (DE) 10 2013 008 188.2

(51) Int. Cl. A44C 9/00; B32B 38/00; B32B 37/10; B32B 37/14; B32B 37/24

(52) U.S. Cl. CPC A44C 9/00; B32B 37/142; B32B 37/24; B32B 37/10; B32B 38/0012; B32B 2038/0016; B32B 2451/00

(57) ABSTRACT

A jewelry ring that includes a sleeve-like or annular substrate made of a precious metal or a precious metal alloy having a specific density ρ₁, and which has an inner surface for contacting a finger, an outer surface, two lateral surfaces and a central cavity for accommodating the finger. A bundle of fibers is wound in multiple windings on at least a part of the outer surface. The fibers are connected to one another by a plastic adhesive having a specific density of ρ₂<ρ₁. The fibers have a specific density ρ₃<ρ₁. Also a method for manufacturing a jewelry ring, which includes wetting the bundle of fibers with plastic adhesive, fastening a start of the bundle to the sleeve-like or annular substrate, winding the bundle on the sleeve-like or annular substrate, applying pressure to the bundle, curing the plastic adhesive and grinding off peripheral-most fibers.

The invention relates to a jewelry ring according to the preamble of patent claim 1 and a method for manufacturing same according to the preamble of patent claim 6.

Jewelry rings are crafted predominantly from the precious metals gold, platinum, palladium and alloys thereof, which are marked by their high resistance to corrosion, which also ensures a perfect surface of the metal over a very long period of time. The disadvantage of such precious metal jewelry rings is, on the one hand, the high material costs and, on the other hand—as a result of the very high specific density of the metals used—their high absolute weight, in particular, in the case of wide, weighty embodiments, which may adversely affect the wearing comfort.

The invention seeks to remedy this. The object of the invention is to provide a jewelry ring and a method for manufacturing same, which overcomes these disadvantages, but at the same time maintains, or even improves, the high corrosion resistance, the optimal surface characteristics and the advantageous overall visual appearance of the jewelry ring.

The invention achieves the stated object with a jewelry ring, which has the features according to claim 1, and with a method for manufacturing same, which has the features of claim 6.

The advantages achieved by the invention are to be found essentially in that, thanks to the device according to the invention:

a high corrosion resistance is maintained;

the physical and, in particular, visual surface characteristics required of jewelry rings are maintained;

the surface acquires at least partially a silk-like sheen;

the surface has a three-dimensional depth effect; and

the average specific density of the jewelry ring is significantly reduced as compared to pure metal rings;

the total weight of the jewelry ring is significantly reduced as compared to pure metal rings;

the material costs for manufacturing the jewelry ring are considerably reduced.

The density ρ₁ of the precious metal substrate corresponds to the densities for the pure precious metals AU (19.3 g/cm³), platinum (21.4 g/cm³) or palladium (12.0 g/cm³), or of the standard alloys of these precious metals. The density ρ₂ of the plastic adhesives lies typically in the range of 1.2 to 1.6 g/cm³, and the density ρ₃ of the fibers lies typically in the range of 1.3 to 1.8 g/cm³, i.e., significantly lower than the density ρ₁ of the precious metal substrate.

Additional advantageous embodiments of the invention may be commented on as follows:

The bundle of fibers is advantageously a so-called roving, the fibers of which have been twisted. In one embodiment, the bundle of fibers has one twist per 1-10 cm, preferably per 2-4 cm length of the bundle. The outer surface of the jewelry ring may have one or more indentations, in which the bundle is set. The depth of these indentations may lie in the range of 0.4 to 1.0 mm.

The sleeve-like or annular substrate may also have at least two sections having variously sized outer diameters, wherein the sections having the smaller outer diameters may be placed by means of the bundle essentially on the outer diameter of the section having the largest outer diameter.

The transparent plastic adhesive advantageously comprises an epoxy resin and the fibers are made of carbon.

In one particular embodiment, the number of windings is greater than 100, preferably greater than 150.

The carbon fibers preferably have a diameter in the range of 4.5-8 μm, preferably of 5.5-7 μm.

The length of the bundle may be at least 3 m, preferably at least 4 m. The length of the bundle may be at most 6 m, preferably at most 7 m.

In one particular embodiment, the bundle of carbon fibers has at least 500 individual fibers, preferably at least 800 individual fibers. The bundle of carbon fibers may have at most 1,200, preferably at most 1,500 individual fibers.

In one particular embodiment, the fibers are individually or doubly consolidated.

The indentations in the jewelry ring may have both a linear as well as a wavy design.

In one particular embodiment, insular regions that have the outer diameter of the section with the largest outer diameter may be left in the sections having a smaller outer diameter.

A method for manufacturing a jewelry ring according to the invention is characterized by the following method steps:

a) Wetting the bundle of fibers with the transparent plastic adhesive;

b) Fastening the start of the bundled treated with the plastic adhesive to the sleeve-like annular substrate;

c) Winding the bundle on the outer surface of the jewelry ring;

d) Pressing on the bundle wound on the jewelry ring;

e) Curing the plastic adhesive; and

f) Grinding off the peripheral-most fibers.

The plastic adhesive preferably comprises an epoxy resin mixed with a hardener, which contains, in particular, a Bisphenol A and/or Bishpenol F-based epoxy. The viscosity of the epoxy resin lies advantageously in the range of 350-450 mPa s at 25° C.

The hardener for the epoxy resin is preferably a cycloaliphatic amine. The viscosity of the hardener lies expediently in the range of 180-230 mPa s at 25° C.

The curing of the epoxy resin may typically take place at a temperature of 55-65° C. for a period of 2.5 to 3.5 hours.

The start of the bundle may be expediently fastened by a connection formed as a knot. The winding of the bundle advantageously takes place in a groove or indentation formed in the outer surface of the jewelry ring. The bundle is advantageously twisted about its longitudinal axis prior to being wound.

In one particular embodiment, the groove is roughened prior to fastening of the bundle, preferably by means of a grinding tool, as a result of which an improved bonding with the epoxy resin is obtained.

The winding in step c) of the method may take place by rotating the jewelry ring.

The pressing on in step d) of the method may advantageously take place by means of a heat shrinkable tubing which is caused to shrink when heated. The heat shrinkable tubing, once it is pressed on, may again be removed. The peripheral-most fibers may be expediently ground off on a lathe.

In one particular embodiment, the winding takes place in such a way that the bundle projects peripherally over the groove. This ensures that the groove is completely filled.

The winding in step c) of the method preferably takes place by hand. In this way, the carbon fibers may be fitted specifically to the shape of the ring and or wrapped around “islands”. The bundle may also be wound on the outer surface at an angle alpha >0° relative to the rotational direction of the ring. The bundle may also be wound on the outer surface in slalom-like fashion relative to the rotational direction of the ring.

In one particular embodiment, a circular ring-like disk, which has an outer diameter larger than the jewelry ring, may be temporarily fastened to one or both lateral surfaces. This measure prevents the bundle from being wound beyond the lateral surfaces of the ring.

The weight ratio between the precious metal forming the substrate and the carbon fibers may advantageously range in the area of 13:1 to 5:1.

The invention and refinements of the invention are explained in still greater detail below based on the partially schematic representations of multiple exemplary embodiments, in which:

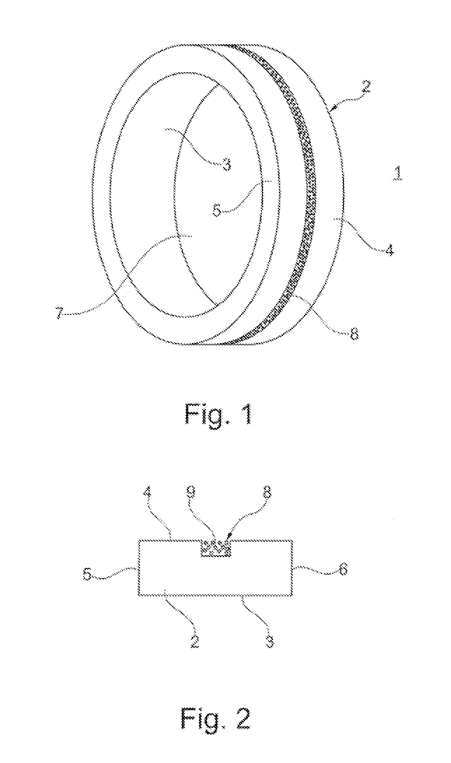

FIG. 1 shows a perspective view of one embodiment of the jewelry ring according to the invention;

FIG. 2 shows a cross-section through the jewelry ring according to FIG. 1;

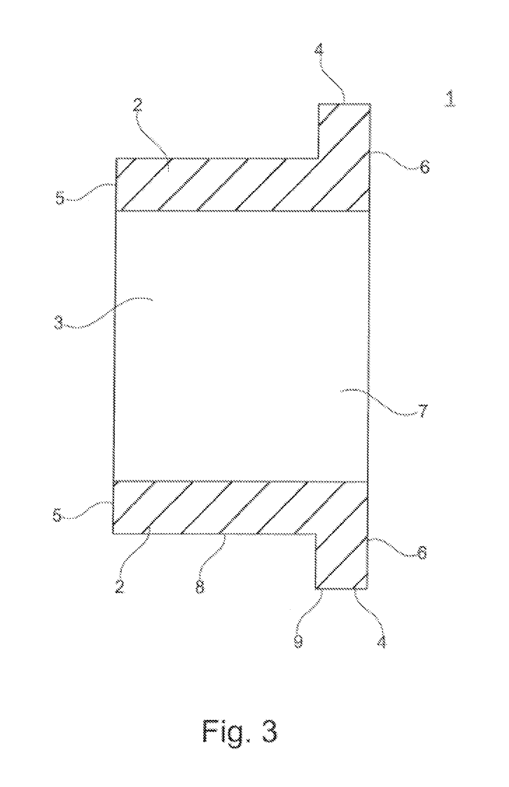

FIG. 3 shows a cross-section through a blank for a jewelry ring;

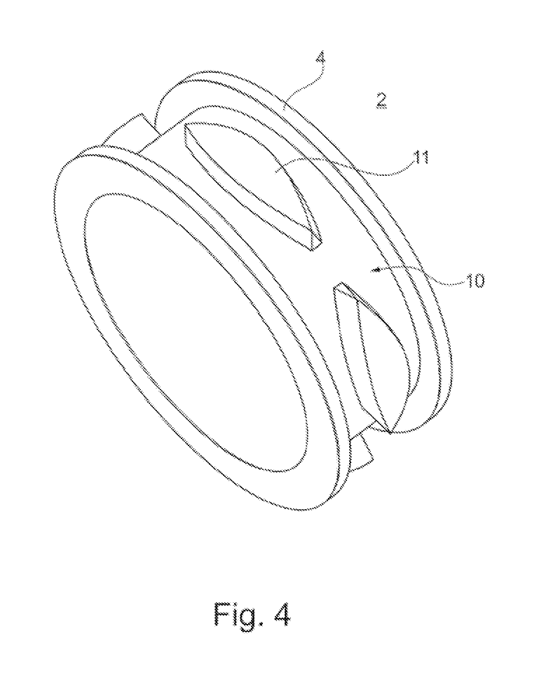

FIG. 4 shows a perspective view of the blank for another embodiment of the jewelry ring according to the invention;

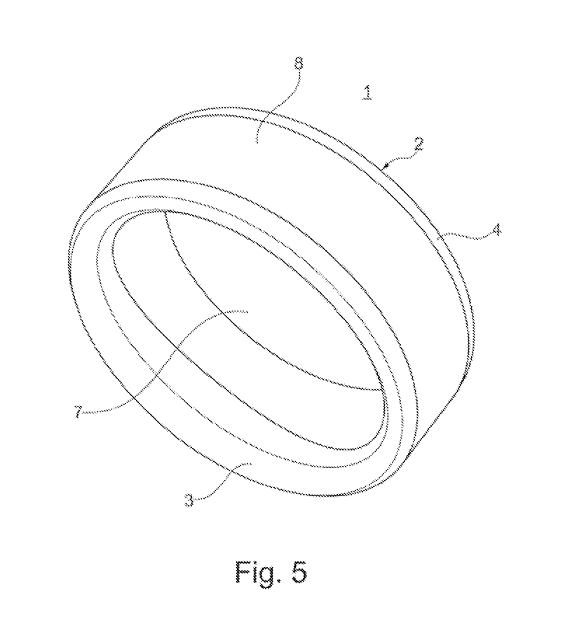

FIG. 5 shows a perspective view again of another embodiment of the jewelry ring according to the invention;

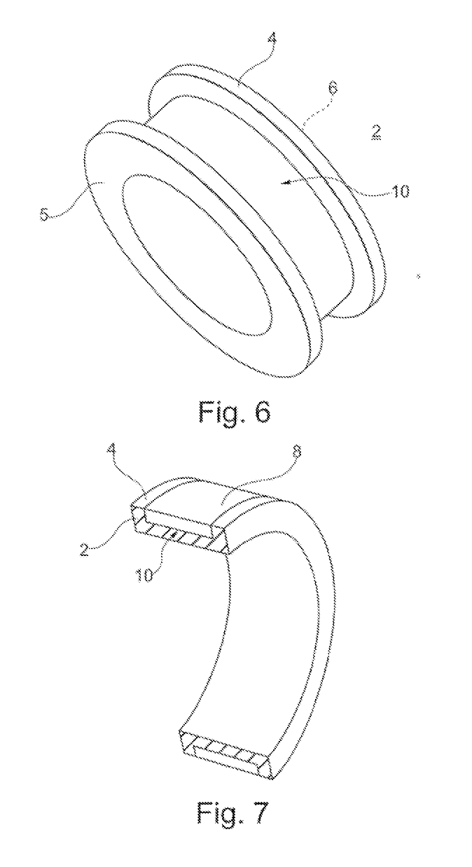

FIG. 6 shows a perspective view of the blank for the embodiment of the jewelry ring according to the invention as seen in FIG. 5; and

FIG. 7 shows a perspective sectional view of the embodiment of the jewelry ring according to the invention as seen in FIG. 5.

The jewelry ring 1 depicted in FIGS. 1 and 2 consist of an annular substrate 2 made of palladium, which has a peripherally circumferential groove 10, in which a roving consisting of a bundle 8 of axially twisted fibers 9 made of carbon having a specific weight of 1.5 g/cm³, and a diameter of 6 μm is wound with approximately 180-200 windings. The fibers 9 are adhered to one another and to the groove 10 by means of a transparent epoxy resin adhesive. The peripheral-most fibers 9 are grounded off. The surface of the bundle 8 has a characteristic silk-like sheen.

FIG. 3 shows a cross-section through a blank for another embodiment of the jewelry ring 1, in which the groove 10 is not bound on one side. To facilitate the winding of the roving, a washer having a diameter corresponding approximately to the right side of the blank is fastened to or pressed onto the left (open) side of the groove 10 during manufacture.

FIG. 4 depicts a blank for another embodiment of the jewelry ring 1. The blank differs from the embodiment depicted in FIGS. 1 and 2, only in that the peripherally circumferential groove 10 is provided with insular areas 11. These insular areas 11 may, for example, have a lenticular cross-sectional surface perpendicular to a radius of the blank, and may extend from the outer face 4 to the bottom of the groove 10. The fibers 9 (not delineated) are wound around the insular areas 11 in slalom-like fashion relative to the rotational direction on the outer surface 4 having the smaller outer diameter.

FIGS. 5 through 7 again depict another embodiment of the jewelry ring 1, which differs from the embodiment depicted in FIGS. 1 and 2, only in that the groove 10 and, therefore, the bundle 8 of fibers 9 exhibits a broader width between the two lateral surfaces 5, 6.

Although, there are different embodiments of the invention, as described above, these are to be understood in the sense that the different features may be used both alone as well as in any arbitrary combination.

Thus, the invention is not limited simply to the aforementioned, particularly preferred embodiments.

1. A jewelry ring adapted to be worn on a finger, the jewelry ring comprising a sleeve-like or annular substrate made of a precious metal or a precious metal alloy having a specific density ρ₁, said sleeve-like or annular substrate having an interior inner surface intended for contact with the finger, an outer surface, two lateral surfaces and a central cavity for accommodating the finger, wherein a bundle of fibers is wound in multiple windings on at least a part of the outer surface, wherein the fibers are connected to one another by means of a plastic adhesive having a specific density of ρ₂<ρ₁; and the fibers have a specific density ρ₃<ρ₁.

2. The jewelry ring according to claim 1, wherein the bundle of fibers is twisted.

3. The jewelry ring according to claim 1, wherein the outer surface has one or multiple indentations, in which the bundle is set.

4. The jewelry ring according to claim 1, wherein the plastic adhesive is transparent and comprises an epoxy resin.

5. The jewelry ring according to claim 1, wherein the fibers are carbon fibers.

6. A method for manufacturing a jewelry ring according to claim 1, comprising:
wetting the bundle of fibers with the plastic adhesive;
fastening a start of the bundle wetted with the plastic adhesive to the sleeve-like or annular substrate;
winding the bundle wetted with the plastic adhesive on the outer surface of the sleeve-like or annular substrate;
applying pressure to the bundle wound on the sleeve-like or annular substrate;
curing the plastic adhesive; and
grinding off peripheral-most fibers.

7. The method according to claim 6, wherein the plastic adhesive comprises an epoxy resin mixed with a hardener.

8. The method according to claim 6, wherein the start of the bundle is attached by a connection formed as a knot.

9. The method according to claim 6, wherein the bundle is wound in a groove or indention set in the outer surface.

10. The method according to claim, wherein the bundle is twisted before being wound.
